(19) United States
(12) Patent Application Publication
(10) Pub. No.: US 2023/0048721 A1
(43) Pub. Date: Feb. 16, 2023

(54) BEAM FOCUSING AND TRACKING FOR AN INTELLIGENT REFLECTING SURFACE BASED ON RECEIVED SIGNAL POWER

(71) Applicant: QUALCOMM Incorporated, San Diego, CA (US)

(72) Inventors: Mehmet Izzet GURELLI, San Diego, CA (US); Qiang WU, San Diego, CA (US); Junyi LI, Fairless Hills, PA (US); Raju HORMIS, New York, NY (US); Tao LUO, San Diego, CA (US); Navid ABEDINI, Basking Ridge, NJ (US); Ozge KOYMEN, Princeton, NJ (US); Farideddin FAYAZBAKHSH, Chatham, NJ (US)

(21) Appl. No.: 17/402,451

(22) Filed: Aug. 13, 2021

(51) Int. Cl. H04B 17/327; H04B 17/382; H04B 1/38

(52) U.S. Cl. CPC H04B 17/327; H04B 17/382; H04B 1/38

(57) ABSTRACT

In an aspect of the disclosure, a method, a computer-readable medium, and an apparatus are provided. The apparatus may be a network node. The apparatus may send, to an IRS, a first configuration for each candidate of a first set of candidates, the first set of candidates including different combinations of a first set of radial distances and a first set of azimuths. The apparatus may communicate an RS with a UE via the IRS after each configuration is sent to the IRS. The apparatus may determine an RSRP of each communicated RS for each candidate of the first set of candidates. The apparatus may send a second configuration to the IRS, the second configuration being based on the determined RSRP.

### TECHNICAL FIELD

The present disclosure relates generally to communication systems, and more particularly, to optimizing and fine-tuning configurations of an intelligent reflecting surface (IRS).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a network node. The apparatus may send, to an IRS, a first configuration for each candidate of a first set of candidates, the first set of candidates including different combinations of a first set of radial distances and a first set of azimuths. The apparatus may communicate a reference signal (RS) with a user equipment (UE) via the IRS after each configuration is sent to the IRS. The apparatus may determine a reference signal received power (RSRP) of each communicated RS for each candidate of the first set of candidates. The apparatus may send a second configuration to the IRS. The second configuration may be based on the determined RSRP.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an environment in which aspects may be practiced.

FIG. 5 is a diagram illustrating various parameters involved in the focusing operation of an IRS.

FIG. 6 is a diagram illustrating example variations of the RSRP as a function of the azimuth.

FIG. 7 is a diagram illustrating example variations of the RSRP as a function of the radial distance.

FIGS. 8A and 8B are diagrams illustrating scale factors used to smooth RSRP gradients with respect to the radial distance.

FIG. 9 is a diagram illustrating example smoothed variations of the RSRP as a function of the radial distance.

FIG. 10 is a communication flow of a method of wireless communication.

FIG. 11 is a flowchart of a method of wireless communication.

FIG. 12 is a flowchart of a method of wireless communication.

FIG. 13 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

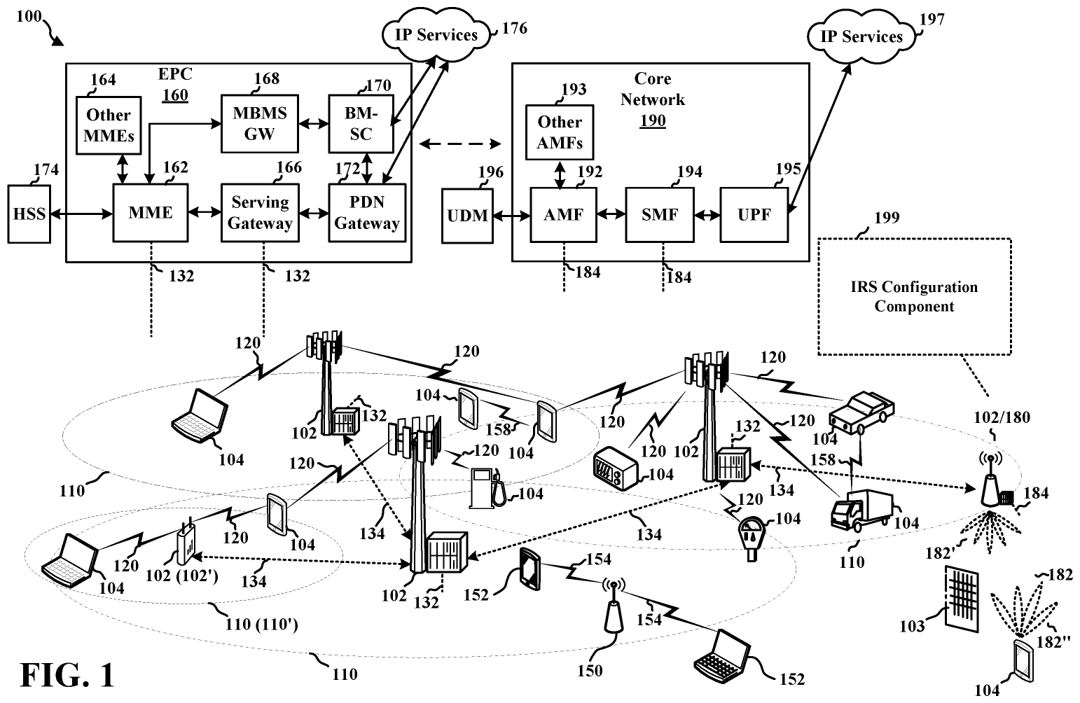

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies.

Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ES S), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the base station/network node 180 may include an IRS configuration component 199 that may be configured to send, to an IRS (e.g., the IRS 103), a first configuration for each candidate of a first set of candidates, the first set of candidates including different combinations of a first set of radial distances and a first set of azimuths. The IRS configuration component 199 may be configured to communicate an RS with a UE via the IRS after each configuration is sent to the IRS. The IRS configuration component 199 may be configured to determine an RSRP of each communicated RS for each candidate of the first set of candidates. The IRS configuration component 199 may be configured to send a second configuration to the IRS. The second configuration may be based on the determined RSRP. Although the following description may be focused on 5G NR, the concepts described herein may be applicable to other similar areas, such as LTE, LTE-A, CDMA, GSM, and other wireless technologies.

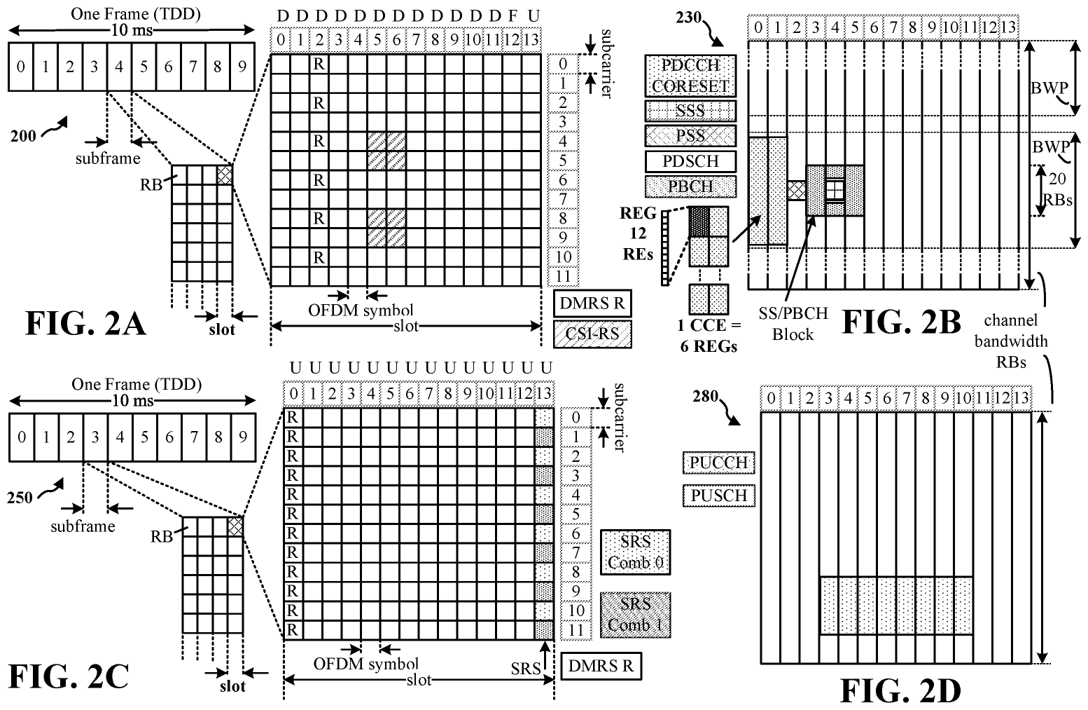

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} − 15 [kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is approximately 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH resource within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

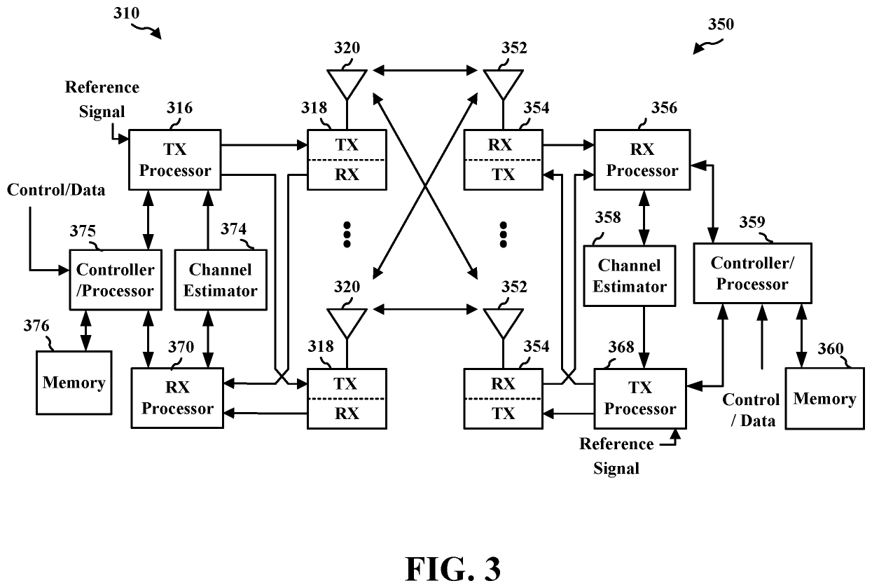

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 316, the RX processor 370, and the controller/processor 375 may be configured to perform aspects in connection with 199 of FIG. 1.

5G wireless standards have created new opportunities for innovation and unprecedented use cases, such as eMBB, URLLC, or eMTC. Among the main drivers behind 5G is the availability of large amounts of spectrum, especially at high bands known as millimeter-wave (mmW) bands. Some of the main challenges of wireless communications at mmW bands may include increased propagation losses, even in line-of-sight (LOS) communications, due to the short wavelength and absorption by various environmental effects, and may also include high diffraction losses that make non-line-of-sight (NLOS) communications difficult.

The success of 5G technologies may be closely related to seamless communications at mmW bands. The massive MIMO technique may be utilized to create high antenna gains (albeit with reduced beamwidths) to compensate for propagation losses. Network densification may refer to the inclusion of more closely spaced base stations. Network densification may involve various layers of components, which may include base stations, remote radio heads (RRHs), various types of repeaters, small cells, femto-cells, and reflecting surfaces. Various types of reflecting surfaces may exist. Examples may include fixed reflecting surfaces, IRSs (or reconfigurable intelligent surfaces “RISs”), or meta-surfaces, etc. The IRSs may either be operator owned or consumer owned.

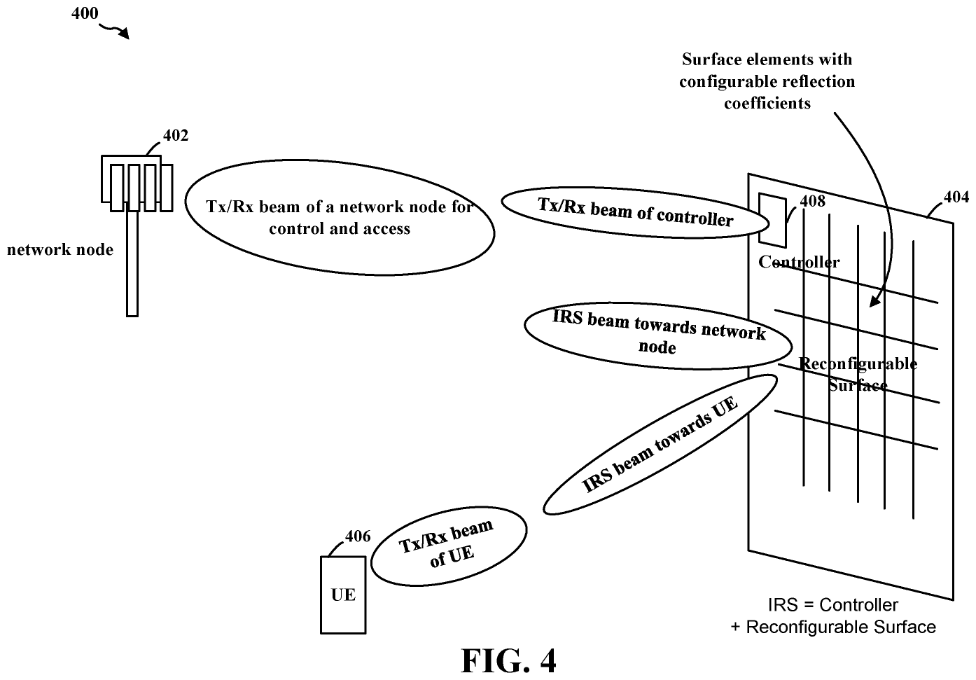

FIG. 4 is a diagram illustrating an environment 400 in which aspects may be practiced. An IRS 404 may include a surface with densely packed small surface elements. Each surface element may have a controllable reflection coefficient. By adjusting the reflection coefficient, the phase shift between the incident and reflected rays to and from the surface element, respectively, may be controlled. The IRS 404 may be controlled by the controller 408, which may be configured based on a IRS configuration message received from the network node 402. Depending on the implementation, various forms of non-ideal effects may take place. For example, the phase shift may have a limited range, or there may be a gain variation that depends on the phase shift. Depending on the implementation, the surface elements may also be referred to as metaatoms.

When the surface phase (that is, the phases of the surface elements) is properly set, the beam from the network node 402 may be reflected by the IRS 404 toward the UE 406 in downlink. Conversely, the beam from the UE 406 may be reflected by the IRS 404 toward the network node 402 in uplink. Accordingly, the IRS 404 may help to reduce the pathloss and avoid blockages in the LOS propagation. The network node 402 may be any of a base station, an RRH, a repeater, etc. Although herein aspects may be described in relation to 5G and mmW bands, the aspects may be equally applicable to other technologies such as 4G LTE, IEEE 802.11 WIFI, or future generations of technologies including beyond 5G, 6G, etc., and to other bands such as the sub-6 GHz bands, terahertz bands, etc.

An IRS (e.g., the IRS 404) may implement a focusing operation to beamform toward a UE (e.g., the UE 406), where the phases of received rays may align. Unlike conventional beamforming, focusing may take into account the radial distance of the UE from the IRS, in addition to the azimuth and the elevation of the UE. Focusing may be achieved by setting the surface phase of the IRS in a particular way.

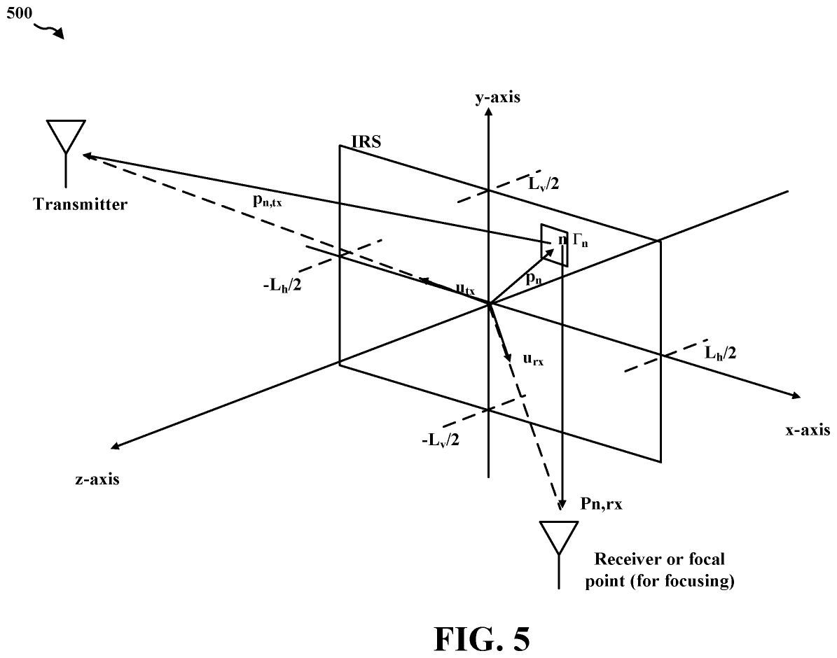

FIG. 5 is a diagram 500 illustrating various parameters involved in the focusing operation of an IRS. As illustrated, p_{n,tx} may be a vector from the surface element n to the Tx point. p_{n,rx} may be a vector from the surface element n to the Rx point. pₙ may be a vector from the origin to the surface element n. uₜₓ may be a unit-vector from the origin to the Tx point. uᵣₓ may be a unit-vector from the origin to the Rx point. Γₙ may be the reflection coefficient at the surface element n. To focus from the Tx point tx to the Rx point Γx1, Γₙ=exp (j2 π(d_{n,tx}+d_{n,rx})/λ), where d_{n,tx}=|p_{n,tx}| and d_{n,rx}=|p_{n,rx}|, is the operating wavelength.

According to some aspects, an IRS may form and track a focused beam towards a UE. Focusing may mean that in downlink all rays produced by the network node and reflected by the IRS may be received by the UE in phase. For the uplink, all rays transmitted by the UE may be received by the network node in phase. Compared to the conventional beamforming, focused beamforming may take into account not just the azimuth and the elevation of the target (e.g., the UE) from the point of reflection (e.g., the IRS), but also the distance from each reflective point on the IRS to the target, as described above. In some aspects, in addition to forming a focused beam, the beam may also track the movement of the target (e.g., the UE) relative to the IRS. It may be assumed that an initial coarse beam targeting has already been achieved. In other words, the reflected beam from the IRS may be pointed in the general direction of the UE, but not all rays may be phase aligned for the maximum signal-to-interference-plus-noise-ratio (SINR). RSRP measurements may be utilized to achieve a focused beam. The RSRP measurements may be based on the SSB, the CSI-RS, or the SRS.

In a first stage, a coarse radial distance may be detected with azimuth refinement based on testing of candidates. Starting with an initially known coarse azimuth (and elevation), a set of coarse radial distance and refined azimuth candidate values may be sequentially sent to the IRS by the network node. After each candidate configuration is transmitted to the IRS, and the IRS is reconfigured based on the present candidate configuration, the network node may determine an RSRP measurement associated with the present candidate configuration. In one configuration, the network node may transmit an SSB or a CSI-RS, and the RSRP measurement may be made at the UE. The network node may receive the result of the RSRP measurement from the UE. In another configuration, the UE may transmit an SRS, and the RSRP measurement may be made by the network node. The best or highest RSRP measurement may be used to determine a coarse radial distance estimate and a refined azimuth.

For example, the set of candidate radial distance values to test may be {100, 60, 40, 30, 20, 15, 10, 8, 6, 4} (meters), and the set of refined candidate azimuth values (around the initially known coarse azimuth value) to test may be {−0.6, −0.3, 0, 0.3, 0.6} (degrees), resulting in a total of 10×5=50 candidate configurations to test.

In one configuration, the first stage may be repeated one or more times with a new set of radial distance and azimuth candidates over an ever smaller set of values centered around the best candidate found in the preceding round. For example, if the best candidate found in the preceding round is {20 meters, 0 degrees}, then the new set of candidate values may be {28, 24, 20, 18, 16} (meters) and {−0.1, 0, 0.1} (degrees), which are centered around the best azimuth estimate from the preceding round. In one configuration, elevation candidate values may also be tested in this stage.

In a second stage, gradient-based focusing may be performed, with the result from the first stage described above as the starting point. An iterative gradient ascent process may be utilized to find a configuration that corresponds to a local maximum of the RSRP measurement. In particular, in each iteration, small perturbations to at least one of the beam azimuth, elevation, or radial distance in the IRS configuration may be introduced. The network node may send the new candidate configuration to the IRS. The IRS may reconfigure itself based on the most recent candidate configuration. An RSRP measurement may then be obtained. A gradient may be estimated for at least one of the beam azimuth, elevation, or radial distance, and the at least one of the beam azimuth, elevation, or radial distance may be updated with small increments in the estimated gradient direction. In other words, each subsequent candidate may include a radial distance, an azimuth, or an elevation that is incremented or decremented by a step size relative to a radial distance, an azimuth, or an elevation, respectively, of a previous candidate in a direction of a gradient of an RSRP corresponding to the previous candidate.

It should be appreciated that the first stage (e.g., the coarse detection stage) may be desired before the gradient-based focusing is performed because without the coarse detection, it may take a large number of iterations and a long time for the gradient-based focusing process to converge on a best configuration, and also because without the coarse detection to place the starting point of the gradient-based focusing near the global maximum, the gradient-based focusing process may converge on a local maximum that is not the global maximum.

The gradient-based focusing may be continually repeated, but may be slowed down (i.e., with less frequent measurements) after sufficient convergence is achieved.

In a third stage, a beam tracking process may be performed. The beam tracking process may be understood as a continuation of the gradient-based focusing with possibly less frequent updates and smaller step sizes. In one configuration, if the measured RSRP significantly degrades, the process may return to the coarse detection stage. If the problem is not resolved, it may be possible that the UE is moving out of the coverage area of the IRS. Accordingly, an appropriate action may be taken to update the serving IRS information.

In some aspects, the network node may communicate with the UE via the IRS based on the best IRS configuration found in the coarse detection stage. In some aspects, the network node may communicate with the UE via the IRS based on the best IRS configuration found in the gradient-based focusing process.

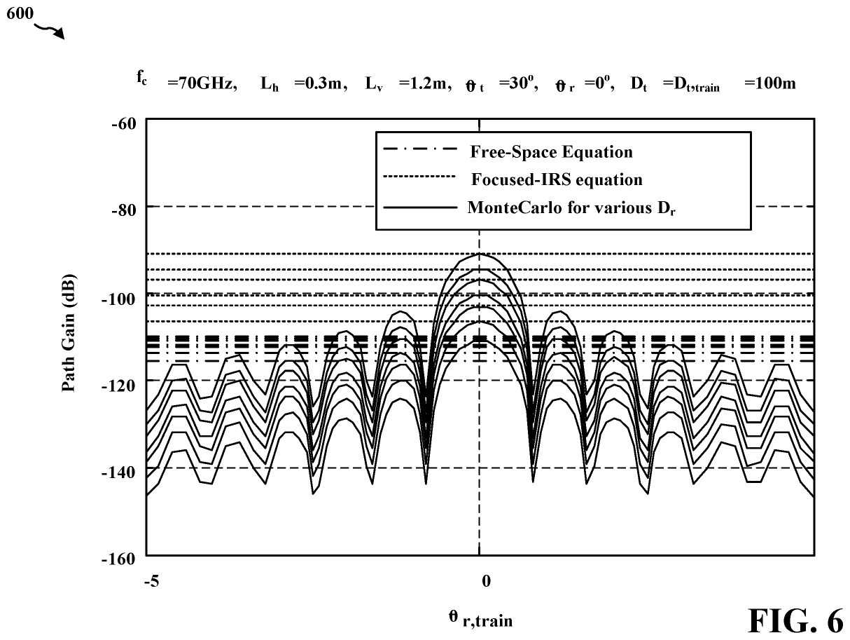

FIG. 6 is a diagram 600 illustrating example variations of the RSRP as a function of the azimuth. The gradient-based focusing process described above may be negatively impacted by steep RSRP gradients. As the steep gradients may cause the gradient-based focusing process to overshoot easily, the performance of the process may degrade. Accordingly, to alleviate the issue, RSRP gradients may be smoothed as needed before the gradient-based focusing process is performed. The gradient of the RSRP with respect to the azimuth may be made smoother by reducing the horizontal width of the active area of the IRS. The gradient of the RSRP with respect to the elevation may be made smoother by reducing the vertical width of the active area of the IRS.

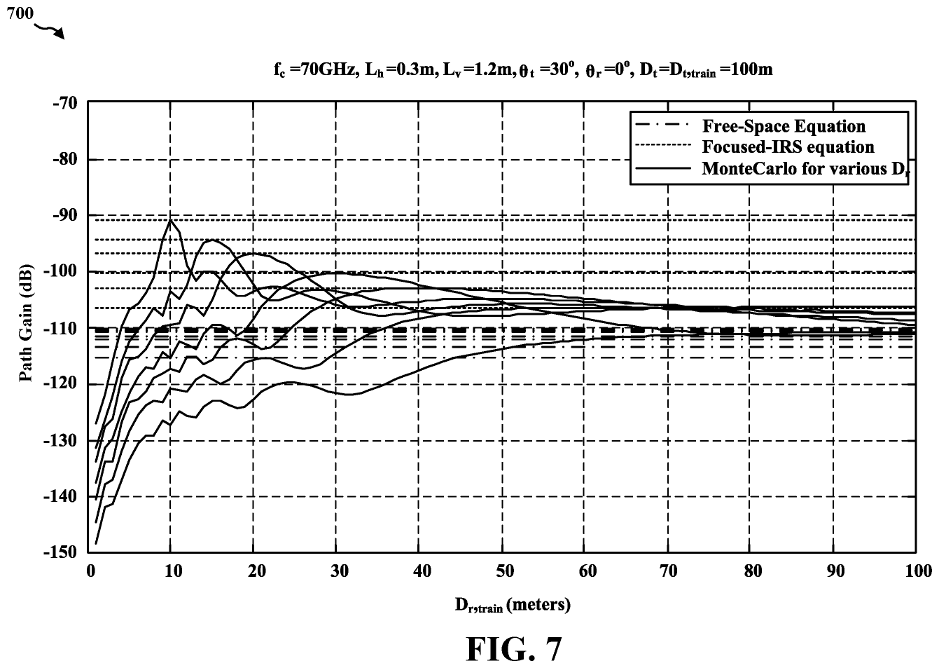

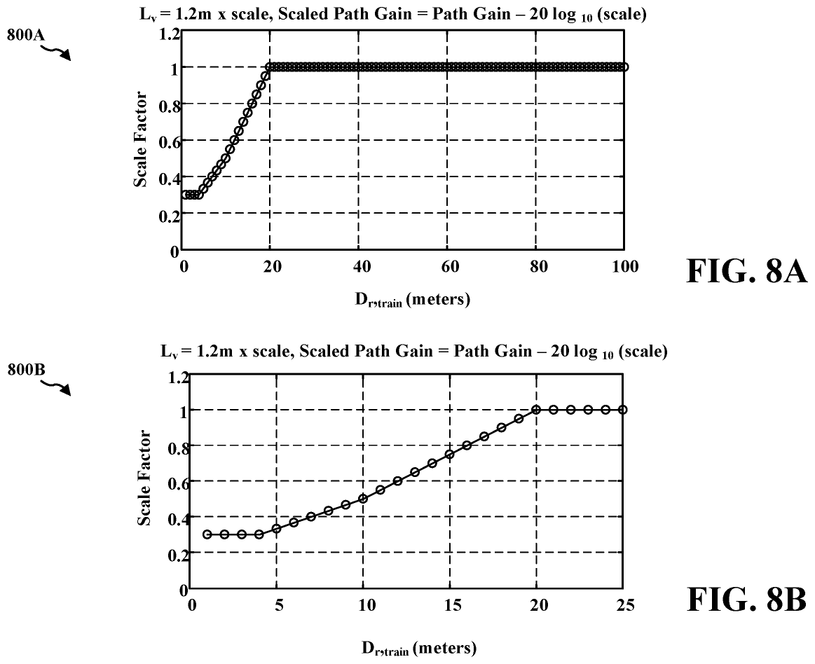

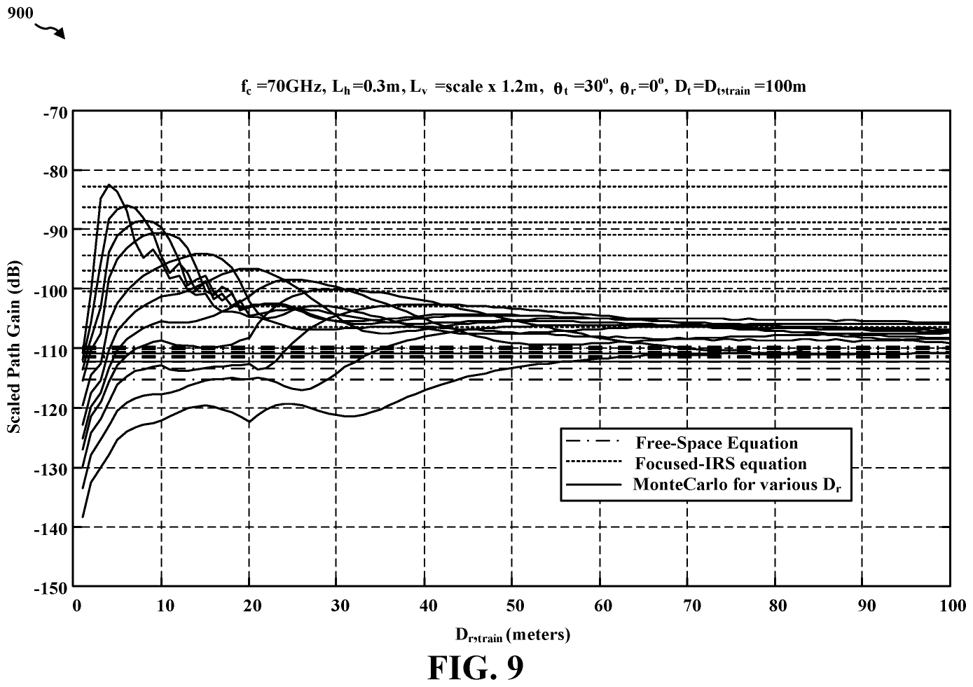

FIG. 7 is a diagram 700 illustrating example variations of the RSRP as a function of the radial distance. The gradient of the RSRP with respect to the radial distance may vary from being smooth in the far field to being steep closer to the IRS. Therefore, more aggressive smoothing may be applied to RSRP gradients closer to the IRS. FIGS. 8A and 8B are diagrams 800A and 800B, respectively, illustrating scale factors used to smooth RSRP gradients with respect to the radial distance. Lower scale factors may be used where the radial distance is small, and the scale factors may increase as the radial distance increases. In particular, to smooth the gradient of the RSRP with respect to the radial distance, for a given radial distance candidate, the vertical width Lᵥ of the active area of the IRS may be reduced by a radial distance-dependent scale factor s, where s<=1. Then, the RSRP measurement may be increased by the factor 1/s² (i.e., the inverse of the scale factor used for IRS active area scaling squared) to compensate for the drop in the RSRP as a result of reducing the vertical width Lᵥ of the active area. FIG. 9 is a diagram 900 illustrating example smoothed variations of the RSRP as a function of the radial distance.

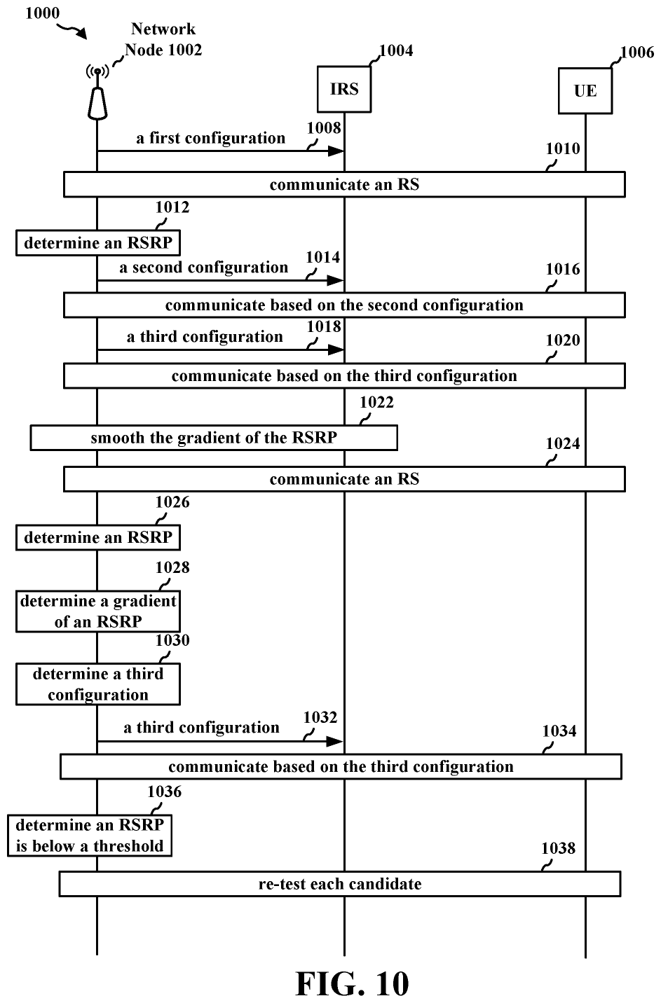

FIG. 10 is a communication flow 1000 of a method of wireless communication. At 1008, the network node 1002 may send, to an IRS 1004, a first configuration for each candidate of a first set of candidates. The first set of candidates may include different combinations of a first set of radial distances and a first set of azimuths. At 1010, the network node 1002 may communicate an RS with a UE 1006 via the IRS 1004 after each configuration is sent to the IRS 1004. At 1012, the network node 1002 may determine an RSRP of each communicated RS for each candidate of the first set of candidates. At 1014, the network node 1002 may send a second configuration to the IRS 1004. The second configuration may be based on the determined RSRP.

In one configuration, the first set of candidates may include different combinations of the first set of radial distances, the first set of azimuths, and a first set of elevations.

In one configuration, the network node 1002 communicating the RS with the UE 1006 via the IRS 1004 may include the network node 1002 transmitting at least one of an SSB or a CSI-RS to the UE 1006 via the IRS 1004. In one configuration, the network node 1002 determining the RSRP of each communicated RS for each candidate of the first set of candidates may include the network node 1002 receiving, from the UE 1006, the RSRP of each RS transmitted to the UE 1006 via the IRS 1004 for each candidate of the first set of candidates.

In one configuration, the network node 1002 communicating the RS with the UE 1006 via the IRS 1004 may include the network node 1002 receiving an SRS from the UE 1006 via the IRS 1004. In one configuration, the network node 1002 determining the RSRP of each communicated RS for each candidate of the first set of candidates may include the network node 1002 measuring the RSRP of each RS received from the UE 1006 via the IRS 1004 for each candidate of the first set of candidates.

In one configuration, at 1016, the network node 1002 may communicate with the UE 1006 via the IRS 1004 based on the second configuration. The second configuration may be for a candidate in the first set of candidates that corresponds to a highest RSRP.

In one configuration, the network node 1002 may send the second configuration to the IRS 1004 for each candidate of a second set of candidates. The second set of candidates may include different combinations of a second set of radial distances and a second set of azimuths. The second set of radial distances may have a smaller range than the first set of radial distances. The second set of azimuths may have a smaller range than the first set of azimuths. In one configuration, the first set of radial distances may include d₁ radial distances. The first set of azimuths may include a₁ azimuths. The second set of radial distances may include d₂ radial distances. And the second set of azimuths may include a₂ azimuths, where d₂<d₁ and a₂<a₁. In one configuration, the second set of candidates may include different combinations of the second set of radial distances, the second set of azimuths, and a second set of elevations.

In one configuration, at 1018, the network node 1002 may send a third configuration to the IRS 1004. The third configuration may be for a candidate in the second set of candidates that corresponds to a highest RSRP. At 1020, the network node 1002 may communicate with the UE 1006 via the IRS 1004 based on the third configuration.

In one configuration, at 1022, the network node 1002 may smooth the gradient of the RSRP corresponding to the candidate with respect to at least one of the radial distance, the azimuth, or the elevation of the candidate.

In one configuration, the network node 1002 smoothing the gradient of the RSRP corresponding to the candidate with respect to the radial distance may include the network node 1002 sending a fourth configuration to the IRS 1004 to scale down a vertical or a horizontal width of an active area of the IRS by a scale factor and scaling the RSRP based on the scale factor. The network node 1002 smoothing the gradient of the RSRP corresponding to the candidate with respect to the azimuth may include the network node 1002 sending a fifth configuration to the IRS 1004 to reduce the horizontal width of the active area of the IRS 1004. The network node 1002 smoothing the gradient of the RSRP corresponding to the candidate with respect to the elevation may include the network node 1002 sending a sixth configuration to the IRS 1004 to reduce the vertical width of the active area of the IRS 1004.

In one configuration, at 1024, the network node 1002 may communicate, for each iteration of an iterative gradient ascent process, an RS with the UE 1006 via the IRS 1004 after the second configuration is sent to the IRS 1004. At 1026, the network node 1002 may determine, for each iteration, the RSRP corresponding to the RS communicated in the iteration. At 1028, the network node 1002 may determine, for each iteration, a gradient of the RSRP with respect to at least one of a radial distance, an azimuth, or an elevation of the second configuration. At 1030, the network node 1002 may determine a third configuration based on the iterative gradient ascent process and the determined gradients. The third configuration may correspond to a local maximum of the RSRP. At 1032, the network node 1002 may send the third configuration to the IRS 1004.

In one configuration, in the iterative gradient ascent process, each subsequent candidate may include a radial distance, an azimuth, or an elevation that is incremented or decremented by a step size relative to a radial distance, an azimuth, or an elevation, respectively, of a previous candidate in a direction of a gradient of an RSRP corresponding to the previous candidate.

In one configuration, at 1034, the network node 1002 may communicate with the UE 1006 via the IRS 1004 based on the third configuration. At 1036, the network node 1002 may determine that an RSRP corresponding to the third configuration is below a threshold. At 1038, the network node 1002 may re-test, with the IRS 1004, each candidate of the first set of candidates.

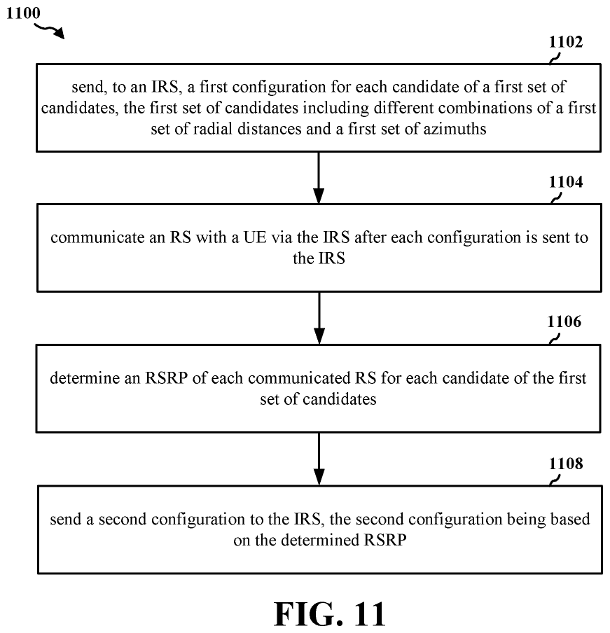

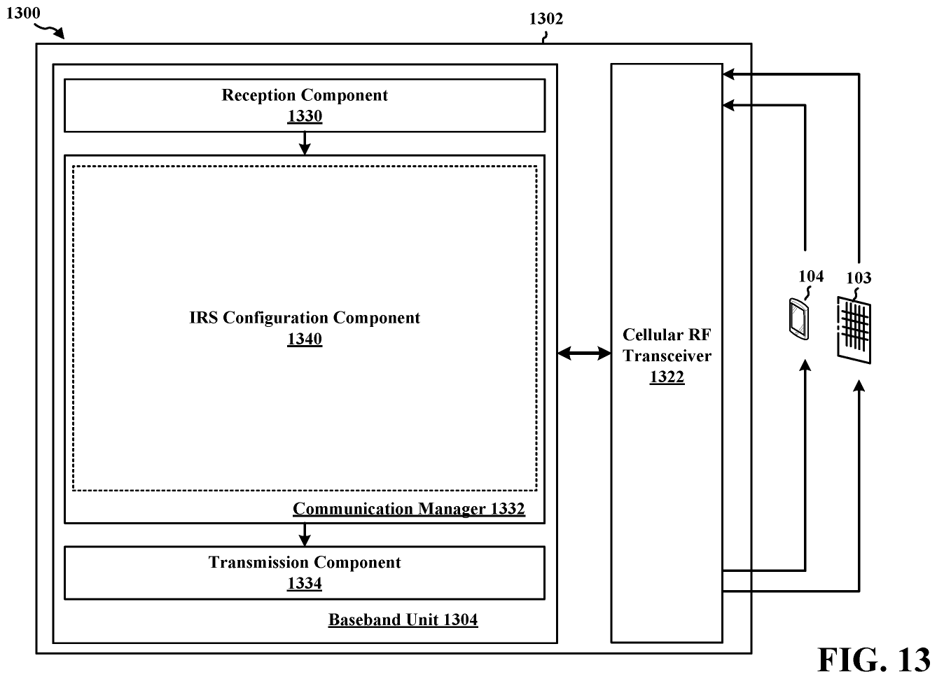

FIG. 11 is a flowchart 1100 of a method of wireless communication. The method may be performed by a network node (e.g., the base station/network node 102/180/310/402/1002; the apparatus 1302). At 1102, the network node may send, to an IRS, a first configuration for each candidate of a first set of candidates. The first set of candidates may include different combinations of a first set of radial distances and a first set of azimuths. For example, 1102 may be performed by the IRS configuration component 1340 in FIG. 13. Referring to FIG. 10, at 1008, the network node 1002 may send, to an IRS 1004, a first configuration for each candidate of a first set of candidates.

At 1104, the network node may communicate an RS with a UE via the IRS after each configuration is sent to the IRS. For example, 1104 may be performed by the IRS configuration component 1340 in FIG. 13. Referring to FIG. 10, at 1010, the network node 1002 may communicate an RS with a UE 1006 via the IRS 1004 after each configuration is sent to the IRS 1004.

At 1106, the network node may determine an RSRP of each communicated RS for each candidate of the first set of candidates. For example, 1106 may be performed by the IRS configuration component 1340 in FIG. 13. Referring to FIG. 10, at 1012, the network node 1002 may determine an RSRP of each communicated RS for each candidate of the first set of candidates.

At 1108, the network node may send a second configuration to the IRS. The second configuration may be based on the determined RSRP. For example, 1108 may be performed by the IRS configuration component 1340 in FIG. 13. Referring to FIG. 10, at 1014, the network node 1002 may send a second configuration to the IRS 1004.

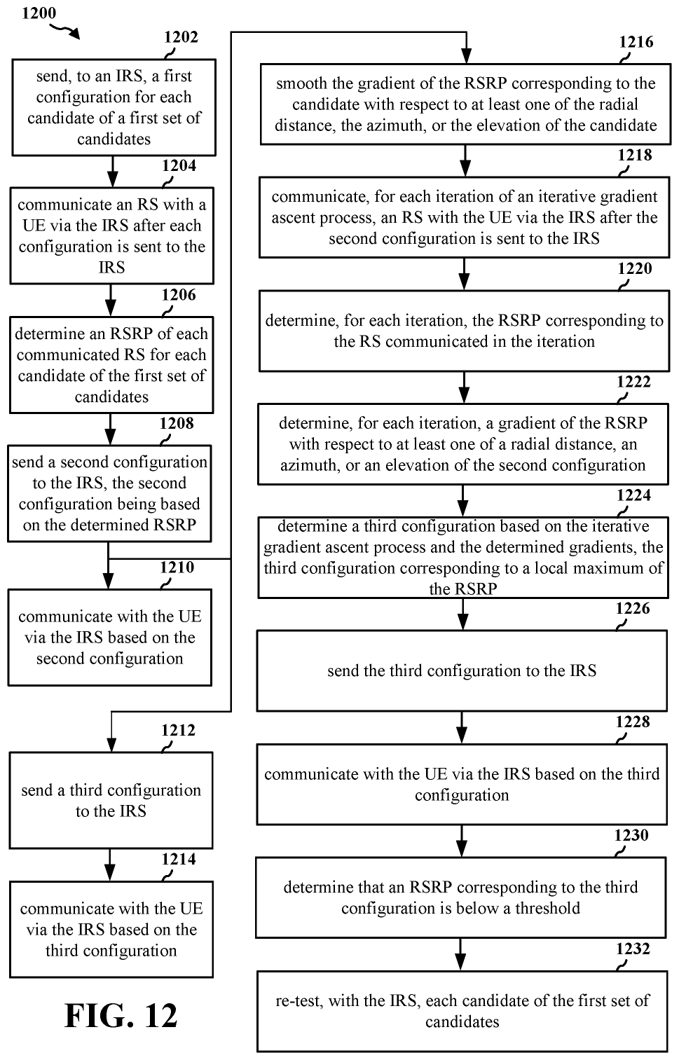

FIG. 12 is a flowchart 1200 of a method of wireless communication. The method may be performed by a network node (e.g., the base station/network node 102/180/310/402/1002; the apparatus 1302). At 1202, the network node may send, to an IRS, a first configuration for each candidate of a first set of candidates. The first set of candidates may include different combinations of a first set of radial distances and a first set of azimuths. For example, 1202 may be performed by the IRS configuration component 1340 in FIG. 13. Referring to FIG. 10, at 1008, the network node 1002 may send, to an IRS 1004, a first configuration for each candidate of a first set of candidates.

At 1204, the network node may communicate an RS with a UE via the IRS after each configuration is sent to the IRS. For example, 1204 may be performed by the IRS configuration component 1340 in FIG. 13. Referring to FIG. 10, at 1010, the network node 1002 may communicate an RS with a UE 1006 via the IRS 1004 after each configuration is sent to the IRS 1004.

At 1206, the network node may determine an RSRP of each communicated RS for each candidate of the first set of candidates. For example, 1206 may be performed by the IRS configuration component 1340 in FIG. 13. Referring to FIG. 10, at 1012, the network node 1002 may determine an RSRP of each communicated RS for each candidate of the first set of candidates.

At 1208, the network node may send a second configuration to the IRS. The second configuration may be based on the determined RSRP. For example, 1208 may be performed by the IRS configuration component 1340 in FIG. 13. Referring to FIG. 10, at 1014, the network node 1002 may send a second configuration to the IRS 1004.

In one configuration, the first set of candidates may include different combinations of the first set of radial distances, the first set of azimuths, and a first set of elevations.

In one configuration, the communicating the RS with the UE via the IRS may include transmitting at least one of an SSB or a channel state information CSI-RS to the UE via the IRS. In one configuration, the determining the RSRP of each communicated RS for each candidate of the first set of candidates may include receiving, from the UE, the RSRP of each RS transmitted to the UE via the IRS for each candidate of the first set of candidates.

In one configuration, the communicating the RS with the UE via the IRS may include receiving an SRS from the UE via the IRS. In one configuration, the determining the RSRP of each communicated RS for each candidate of the first set of candidates may include measuring the RSRP of each RS received from the UE via the IRS for each candidate of the first set of candidates.

In one configuration, the second configuration may be sent to the IRS for each candidate of a second set of candidates. The second set of candidates may include different combinations of a second set of radial distances and a second set of azimuths. The second set of radial distances may have a smaller range than the first set of radial distances. The second set of azimuths may have a smaller range than the first set of azimuths. In one configuration, the first set of radial distances may include d₁ radial distances. The first set of azimuths may include a₁ azimuths. The second set of radial distances may include d₂ radial distances. And the second set of azimuths may include a₂ azimuths, where d₂<d₁ and a₂<a₁. In one configuration, the second set of candidates may include different combinations of the second set of radial distances, the second set of azimuths, and a second set of elevations.

In one configuration, at 1212, the network node may send a third configuration to the IRS. The third configuration may be for a candidate in the second set of candidates that corresponds to a highest RSRP. For example, 1212 may be performed by the IRS configuration component 1340 in FIG. 13. Referring to FIG. 10, at 1018, the network node 1002 may send a third configuration to the IRS 1004.

At 1214, the network node may communicate with the UE via the IRS based on the third configuration. For example, 1214 may be performed by the IRS configuration component 1340 in FIG. 13. Referring to FIG. 10, at 1020, the network node 1002 may communicate with the UE 1006 via the IRS 1004 based on the third configuration.

In one configuration, at 1218, the network node may communicate, for each iteration of an iterative gradient ascent process, an RS with the UE via the IRS after the second configuration is sent to the IRS. For example, 1218 may be performed by the IRS configuration component 1340 in FIG. 13. Referring to FIG. 10, at 1024, the network node 1002 may communicate, for each iteration of an iterative gradient ascent process, an RS with the UE 1006 via the IRS 1004 after the second configuration is sent to the IRS 1004.

At 1220, the network node may determine, for each iteration, the RSRP corresponding to the RS communicated in the iteration. For example, 1220 may be performed by the IRS configuration component 1340 in FIG. 13. Referring to FIG. 10, at 1026, the network node 1002 may determine, for each iteration, the RSRP corresponding to the RS communicated in the iteration.

At 1222, the network node may determine, for each iteration, a gradient of the RSRP with respect to at least one of a radial distance, an azimuth, or an elevation of the second configuration. For example, 1222 may be performed by the IRS configuration component 1340 in FIG. 13. Referring to FIG. 10, at 1028, the network node 1002 may determine, for each iteration, a gradient of the RSRP with respect to at least one of a radial distance, an azimuth, or an elevation of the second configuration.

At 1224, the network node may determine a third configuration based on the iterative gradient ascent process and the determined gradients. The third configuration may correspond to a local maximum of the RSRP. For example, 1224 may be performed by the IRS configuration component 1340 in FIG. 13. Referring to FIG. 10, at 1030, the network node 1002 may determine a third configuration based on the iterative gradient ascent process and the determined gradients.

At 1226, the network node may send the third configuration to the IRS. For example, 1226 may be performed by the IRS configuration component 1340 in FIG. 13. Referring to FIG. 10, at 1032, the network node 1002 may send the third configuration to the IRS 1004.

In one configuration, in the iterative gradient ascent process, each subsequent candidate may include a radial distance, an azimuth, or an elevation that is incremented or decremented by a step size relative to a radial distance, an azimuth, or an elevation, respectively, of a previous candidate in a direction of a gradient of an RSRP corresponding to the previous candidate.

In one configuration, at 1216, the network node may smooth the gradient of the RSRP corresponding to the candidate with respect to at least one of the radial distance, the azimuth, or the elevation of the candidate. For example, 1216 may be performed by the IRS configuration component 1340 in FIG. 13. Referring to FIG. 10, at 1022, the network node 1002 may smooth the gradient of the RSRP corresponding to the candidate with respect to at least one of the radial distance, the azimuth, or the elevation of the candidate.

In one configuration, smoothing the gradient of the RSRP corresponding to the candidate with respect to the radial distance may include sending a fourth configuration to the IRS to scale down a vertical or a horizontal width of an active area of the IRS by a scale factor and scaling the RSRP based on the scale factor. Smoothing the gradient of the RSRP corresponding to the candidate with respect to the azimuth may include sending a fifth configuration to the IRS to reduce the horizontal width of the active area of the IRS. Smoothing the gradient of the RSRP corresponding to the candidate with respect to the elevation may include sending a sixth configuration to the IRS to reduce the vertical width of the active area of the IRS.

In one configuration, at 1228, the network node may communicate with the UE via the IRS based on the third configuration. For example, 1228 may be performed by the IRS configuration component 1340 in FIG. 13. Referring to FIG. 10, at 1034, the network node 1002 may communicate with the UE 1006 via the IRS 1004 based on the third configuration.

At 1230, the network node may determine that an RSRP corresponding to the third configuration is below a threshold. For example, 1230 may be performed by the IRS configuration component 1340 in FIG. 13. Referring to FIG. 10, at 1036, the network node 1002 may determine that an RSRP corresponding to the third configuration is below a threshold.

At 1232, the network node may re-test, with the IRS, each candidate of the first set of candidates. For example, 1232 may be performed by the IRS configuration component 1340 in FIG. 13. Referring to FIG. 10, at 1038, the network node 1002 may re-test, with the IRS 1004, each candidate of the first set of candidates.

In one configuration, at 1210, the network node may communicate with the UE via the IRS based on the second configuration. The second configuration may be for a candidate in the first set of candidates that corresponds to a highest RSRP. For example, 1210 may be performed by the IRS configuration component 1340 in FIG. 13. Referring to FIG. 10, at 1016, the network node 1002 may communicate with the UE 1006 via the IRS 1004 based on the second configuration.

FIG. 13 is a diagram 1300 illustrating an example of a hardware implementation for an apparatus 1302. The apparatus 1302 may be a base station/network node, a component of a base station/network node, or may implement base station/network node functionality. In some aspects, the apparatus 1302 may include a baseband unit 1304. The baseband unit 1304 may communicate through a cellular RF transceiver 1322 with the UE 104. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the base station 310 and may include the memory 376 and/or at least one of the TX processor 316, the RX processor 370, and the controller/processor 375.

The communication manager 1332 may include an IRS configuration component 1340 that may be configured to send, to an IRS, a first configuration for each candidate of a first set of candidates, e.g., as described in connection with 1202 in FIG. 12. The IRS configuration component 1340 may be further configured to communicate an RS with a UE via the IRS after each configuration is sent to the IRS, e.g., as described in connection with 1204 in FIG. 12. The IRS configuration component 1340 may be further configured to determine an RSRP of each communicated RS for each candidate of the first set of candidates, e.g., as described in connection with 1206 in FIG. 12. The IRS configuration component 1340 may be further configured to send a second configuration to the IRS. The second configuration may be based on the determined RSR, e.g., as described in connection with 1208 in FIG. 12. The IRS configuration component 1340 may be further configured to communicate with the UE via the IRS based on the second configuration, e.g., as described in connection with 1210 in FIG. 12. The IRS configuration component 1340 may be further configured to send a third configuration to the IRS, e.g., as described in connection with 1212 in FIG. 12. The IRS configuration component 1340 may be further configured to communicate with the UE via the IRS based on the third configuration, e.g., as described in connection with 1214 in FIG. 12. The IRS configuration component 1340 may be further configured to smooth the gradient of the RSRP corresponding to the candidate with respect to at least one of the radial distance, the azimuth, or the elevation of the candidate, e.g., as described in connection with 1216 in FIG. 12. The IRS configuration component 1340 may be further configured to communicate, for each iteration of an iterative gradient ascent process, an RS with the UE via the IRS after the second configuration is sent to the IRS, e.g., as described in connection with 1218 in FIG. 12. The IRS configuration component 1340 may be further configured to determine, for each iteration, the RSRP corresponding to the RS communicated in the iteration, e.g., as described in connection with 1220 in FIG. 12. The IRS configuration component 1340 may be further configured to determine, for each iteration, a gradient of the RSRP with respect to at least one of a radial distance, an azimuth, or an elevation of the second configuration, e.g., as described in connection with 1222 in FIG. 12. The IRS configuration component 1340 may be further configured to determine a third configuration based on the iterative gradient ascent process and the determined gradients, e.g., as described in connection with 1224 in FIG. 12. The IRS configuration component 1340 may be further configured to send the third configuration to the IRS, e.g., as described in connection with 1226 in FIG. 12. The IRS configuration component 1340 may be further configured to communicate with the UE via the IRS based on the third configuration, e.g., as described in connection with 1228 in FIG. 12. The IRS configuration component 1340 may be further configured to determine that an RSRP corresponding to the third configuration is below a threshold, e.g., as described in connection with 1230 in FIG. 12. The IRS configuration component 1340 may be further configured to re-test, with the IRS, each candidate of the first set of candidates, e.g., as described in connection with 1232 in FIG. 12.

The apparatus may include additional components that perform each of the blocks of the algorithm in the flowcharts of FIGS. 10-12. As such, each block in the flowcharts of FIGS. 10-12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1302 may include a variety of components configured for various functions. In one configuration, the apparatus 1302, and in particular the baseband unit 1304, includes means for sending, to an IRS, a first configuration for each candidate of a first set of candidates, the first set of candidates including different combinations of a first set of radial distances and a first set of azimuths. The apparatus 1302 may include means for communicating an RS with a UE via the IRS after each configuration is sent to the IRS. The apparatus 1302 may include means for determining an RSRP of each communicated RS for each candidate of the first set of candidates. The apparatus 1302 may include means for sending a second configuration to the IRS. The second configuration may be based on the determined RSRP.

In one configuration, the first set of candidates may include different combinations of the first set of radial distances, the first set of azimuths, and a first set of elevations. In one configuration, the communicating the RS with the UE via the IRS may include transmitting at least one of an SSB or a channel state information CSI-RS to the UE via the IRS. In one configuration, the determining the RSRP of each communicated RS for each candidate of the first set of candidates may include receiving, from the UE, the RSRP of each RS transmitted to the UE via the IRS for each candidate of the first set of candidates. In one configuration, the communicating the RS with the UE via the IRS may include receiving an SRS from the UE via the IRS. In one configuration, the determining the RSRP of each communicated RS for each candidate of the first set of candidates may include measuring the RSRP of each RS received from the UE via the IRS for each candidate of the first set of candidates. In one configuration, the second configuration may be sent to the IRS for each candidate of a second set of candidates. The second set of candidates may include different combinations of a second set of radial distances and a second set of azimuths. The second set of radial distances may have a smaller range than the first set of radial distances. The second set of azimuths may have a smaller range than the first set of azimuths. In one configuration, the first set of radial distances may include d₁ radial distances. The first set of azimuths may include a₁ azimuths. The second set of radial distances may include d₂ radial distances. And the second set of azimuths may include a₂ azimuths, where d₂<d₁ and a₂<a₁. In one configuration, the second set of candidates may include different combinations of the second set of radial distances, the second set of azimuths, and a second set of elevations. In one configuration, the apparatus 1302 may further include means for sending a third configuration to the IRS. The third configuration may be for a candidate in the second set of candidates that corresponds to a highest RSRP. The apparatus 1302 may further include means for communicating with the UE via the IRS based on the third configuration. In one configuration, the apparatus 1302 may further include means for communicating, for each iteration of an iterative gradient ascent process, an RS with the UE via the IRS after the second configuration is sent to the IRS. The apparatus 1302 may further include means for determining, for each iteration, the RSRP corresponding to the RS communicated in the iteration. The apparatus 1302 may further include means for determining, for each iteration, a gradient of the RSRP with respect to at least one of a radial distance, an azimuth, or an elevation of the second configuration. The apparatus 1302 may further include means for determining a third configuration based on the iterative gradient ascent process and the determined gradients. The third configuration may correspond to a local maximum of the RSRP. The apparatus 1302 may further include means for sending the third configuration to the IRS. In one configuration, in the iterative gradient ascent process, each subsequent candidate may include a radial distance, an azimuth, or an elevation that is incremented or decremented by a step size relative to a radial distance, an azimuth, or an elevation, respectively, of a previous candidate in a direction of a gradient of an RSRP corresponding to the previous candidate. In one configuration, the apparatus 1302 may further include means for smoothing the gradient of the RSRP corresponding to the candidate with respect to at least one of the radial distance, the azimuth, or the elevation of the candidate. In one configuration, smoothing the gradient of the RSRP corresponding to the candidate with respect to the radial distance may include sending a fourth configuration to the IRS to scale down a vertical or a horizontal width of an active area of the IRS by a scale factor and scaling the RSRP based on the scale factor. Smoothing the gradient of the RSRP corresponding to the candidate with respect to the azimuth may include sending a fifth configuration to the IRS to reduce the horizontal width of the active area of the IRS. Smoothing the gradient of the RSRP corresponding to the candidate with respect to the elevation may include sending a sixth configuration to the IRS to reduce the vertical width of the active area of the IRS. In one configuration, the apparatus 1302 may further include means for communicating with the UE via the IRS based on the third configuration. The apparatus 1302 may further include means for determining that an RSRP corresponding to the third configuration is below a threshold. The apparatus 1302 may further include means for re-testing, with the IRS, each candidate of the first set of candidates. In one configuration, the apparatus 1302 may further include means for communicating with the UE via the IRS based on the second configuration, the second configuration may be for a candidate in the first set of candidates that corresponds to a highest RSRP.

The means may be one or more of the components of the apparatus 1302 configured to perform the functions recited by the means. As described supra, the apparatus 1302 may include the TX Processor 316, the RX Processor 370, and the controller/processor 375. As such, in one configuration, the means may be the TX Processor 316, the RX Processor 370, and the controller/processor 375 configured to perform the functions recited by the means.

According to aspects described herein, a network node may send, to an IRS, a first configuration for each candidate of a first set of candidates, the first set of candidates including different combinations of a first set of radial distances and a first set of azimuths. The network node may communicate an RS with a UE via the IRS after each configuration is sent to the IRS. The network node may determine an RSRP of each communicated RS for each candidate of the first set of candidates. The network node may send a second configuration to the IRS, the second configuration being based on the determined RSRP. The network node may further use an iterative gradient ascent method in a gradient-based focusing process to find the best IRS configuration that corresponds to the maximum of the RSRP. The network node may communicate with the UE via the IRS based on the best IRS configuration found. Accordingly, the performance of the IRS-assisted communication may be improved.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a network node including at least one processor coupled to a memory and configured to send, to an IRS, a first configuration for each candidate of a first set of candidates, the first set of candidates including different combinations of a first set of radial distances and a first set of azimuths; communicate an RS with a UE via the IRS after each configuration is sent to the IRS; determine an RSRP of each communicated RS for each candidate of the first set of candidates; and send a second configuration to the IRS, the second configuration being based on the determined RSRP.

Aspect 2 is the apparatus of aspect 1, where the first set of candidates includes different combinations of the first set of radial distances, the first set of azimuths, and a first set of elevations.

Aspect 3 is the apparatus of any of aspects 1 and 2, where the communicating the RS with the UE via the IRS includes transmitting at least one of an SSB or a CSI-RS to the UE via the IRS.

Aspect 4 is the apparatus of aspect 3, where the determining the RSRP of each communicated RS for each candidate of the first set of candidates includes receiving, from the UE, the RSRP of each RS transmitted to the UE via the IRS for each candidate of the first set of candidates.

Aspect 5 is the apparatus of any of aspects 1 and 2, where the communicating the RS with the UE via the IRS includes receiving an SRS from the UE via the IRS.

Aspect 6 is the apparatus of aspect 5, where the determining the RSRP of each communicated RS for each candidate of the first set of candidates includes measuring the RSRP of each RS received from the UE via the IRS for each candidate of the first set of candidates.

Aspect 7 is the apparatus of any of aspects 1 to 6, where the second configuration is sent to the IRS for each candidate of a second set of candidates, the second set of candidates including different combinations of a second set of radial distances and a second set of azimuths, the second set of radial distances having a smaller range than the first set of radial distances, the second set of azimuths having a smaller range than the first set of azimuths.

Aspect 8 is the apparatus of aspect 7, where the first set of radial distances includes d1 radial distances, the first set of azimuths includes a1 azimuths, the second set of radial distances includes d2 radial distances, and the second set of azimuths includes a2 azimuths, where d2<d1 and a2<a1.

Aspect 9 is the apparatus of any of aspects 7 and 8, where the second set of candidates includes different combinations of the second set of radial distances, the second set of azimuths, and a second set of elevations.

Aspect 10 is the apparatus of any of aspects 7 to 9, the at least one processor being further configured to: send a third configuration to the IRS, the third configuration being for a candidate in the second set of candidates that corresponds to a highest RSRP; and communicate with the UE via the IRS based on the third configuration.

Aspect 11 is the apparatus of any of aspects 1 to 6, the at least one processor being further configured to: communicate, for each iteration of an iterative gradient ascent process, an RS with the UE via the IRS after the second configuration is sent to the IRS; determine, for each iteration, the RSRP corresponding to the RS communicated in the iteration; determine, for each iteration, a gradient of the RSRP with respect to at least one of a radial distance, an azimuth, or an elevation of the second configuration; determining a third configuration based on the iterative gradient ascent process and the determined gradients, the third configuration corresponding to a local maximum of the RSRP; and send the third configuration to the IRS.

Aspect 12 is the apparatus of aspect 11, where in the iterative gradient ascent process, each subsequent candidate includes a radial distance, an azimuth, or an elevation that is incremented or decremented by a step size relative to a radial distance, an azimuth, or an elevation, respectively, of a previous candidate in a direction of a gradient of an RSRP corresponding to the previous candidate.

Aspect 13 is the apparatus of aspect 12, the at least one processor being further configured to: smooth the gradient of the RSRP corresponding to the candidate with respect to at least one of the radial distance, the azimuth, or the elevation of the candidate.

Aspect 14 is the apparatus of aspect 13, where smoothing the gradient of the RSRP corresponding to the candidate with respect to the radial distance includes sending a fourth configuration to the IRS to scale down a vertical or a horizontal width of an active area of the IRS by a scale factor and scaling the RSRP based on the scale factor, smoothing the gradient of the RSRP corresponding to the candidate with respect to the azimuth includes sending a fifth configuration to the IRS to reduce the horizontal width of the active area of the IRS, or smoothing the gradient of the RSRP corresponding to the candidate with respect to the elevation includes sending a sixth configuration to the IRS to reduce the vertical width of the active area of the IRS.

Aspect 15 is the apparatus of any of aspects 11 to 14, the at least one processor being further configured to: communicate with the UE via the IRS based on the third configuration; determine that an RSRP corresponding to the third configuration is below a threshold; and re-test, with the IRS, each candidate of the first set of candidates.

Aspect 16 is the apparatus of aspect 1, the at least one processor being further configured to: communicate with the UE via the IRS based on the second configuration, the second configuration being for a candidate in the first set of candidates that corresponds to a highest RSRP.

Aspect 17 is the apparatus of claim 1, further including a transceiver coupled to the at least one processor.

Aspect 18 is a method of wireless communication for implementing any of aspects 1 to 17.

Aspect 19 is an apparatus for wireless communication including means for implementing any of aspects 1 to 17.

Aspect 20 is a computer-readable medium storing computer executable code, where the code when executed by a processor causes the processor to implement any of aspects 1 to 17.

What is claimed is:

1. An apparatus for wireless communication at a network node, comprising:
a memory; and
at least one processor coupled to the memory and configured to:
send, to an intelligent reflecting surface (IRS), a first configuration for each candidate of a first set of candidates, the first set of candidates including different combinations of a first set of radial distances and a first set of azimuths;
communicate a reference signal (RS) with a user equipment (UE) via the IRS after each configuration is sent to the IRS;
determine a reference signal received power (RSRP) of each communicated RS for each candidate of the first set of candidates; and
send a second configuration to the IRS, the second configuration being based on the determined RSRP.

2. The apparatus of claim 1, wherein the first set of candidates includes different combinations of the first set of radial distances, the first set of azimuths, and a first set of elevations.

3. The apparatus of claim 1, wherein the communicating the RS with the UE via the IRS comprises transmitting at least one of a synchronization signal block (SSB) or a channel state information (CSI) RS (CSI-RS) to the UE via the IRS.

4. The apparatus of claim 3, wherein the determining the RSRP of each communicated RS for each candidate of the first set of candidates comprises receiving, from the UE, the RSRP of each RS transmitted to the UE via the IRS for each candidate of the first set of candidates.

5. The apparatus of claim 1, wherein the communicating the RS with the UE via the IRS comprises receiving a sounding reference signal (SRS) from the UE via the IRS.

6. The apparatus of claim 5, wherein the determining the RSRP of each communicated RS for each candidate of the first set of candidates comprises measuring the RSRP of each RS received from the UE via the IRS for each candidate of the first set of candidates.

7. The apparatus of claim 1, wherein the second configuration is sent to the IRS for each candidate of a second set of candidates, the second set of candidates including different combinations of a second set of radial distances and a second set of azimuths, the second set of radial distances having a smaller range than the first set of radial distances, the second set of azimuths having a smaller range than the first set of azimuths.

8. The apparatus of claim 7, wherein the first set of radial distances includes d1 radial distances, the first set of azimuths includes a1 azimuths, the second set of radial distances includes d2 radial distances, and the second set of azimuths includes a2 azimuths, where d2<d1 and a2<a1.

9. The apparatus of claim 7, wherein the second set of candidates includes different combinations of the second set of radial distances, the second set of azimuths, and a second set of elevations.

10. The apparatus of claim 7, the at least one processor being further configured to:
send a third configuration to the IRS, the third configuration being for a candidate in the second set of candidates that corresponds to a highest RSRP; and
communicate with the UE via the IRS based on the third configuration.

11. The apparatus of claim 1, the at least one processor being further configured to:
communicate, for each iteration of an iterative gradient ascent process, an RS with the UE via the IRS after the second configuration is sent to the IRS;
determine, for each iteration, the RSRP corresponding to the RS communicated in the iteration;
determine, for each iteration, a gradient of the RSRP with respect to at least one of a radial distance, an azimuth, or an elevation of the second configuration;
determine a third configuration based on the iterative gradient ascent process and the determined gradients, the third configuration corresponding to a local maximum of the RSRP; and
send the third configuration to the IRS.

12. The apparatus of claim 11, wherein in the iterative gradient ascent process, each subsequent candidate includes a radial distance, an azimuth, or an elevation that is incremented or decremented by a step size relative to a radial distance, an azimuth, or an elevation, respectively, of a previous candidate in a direction of a gradient of an RSRP corresponding to the previous candidate.

13. The apparatus of claim 12, the at least one processor being further configured to:
smooth the gradient of the RSRP corresponding to the candidate with respect to at least one of the radial distance, the azimuth, or the elevation of the candidate.

14. The apparatus of claim 13, wherein smoothing the gradient of the RSRP corresponding to the candidate with respect to the radial distance comprises sending a fourth configuration to the IRS to scale down a vertical or a horizontal width of an active area of the IRS by a scale factor and scaling the RSRP based on the scale factor, smoothing the gradient of the RSRP corresponding to the candidate with respect to the azimuth comprises sending a fifth configuration to the IRS to reduce the horizontal width of the active area of the IRS, or smoothing the gradient of the RSRP corresponding to the candidate with respect to the elevation comprises sending a sixth configuration to the IRS to reduce the vertical width of the active area of the IRS.

15. The apparatus of claim 11, the at least one processor being further configured to:
communicate with the UE via the IRS based on the third configuration;
determine that an RSRP corresponding to the third configuration is below a threshold; and
re-test, with the IRS, each candidate of the first set of candidates.

16. The apparatus of claim 1, the at least one processor being further configured to:
communicate with the UE via the IRS based on the second configuration, the second configuration being for a candidate in the first set of candidates that corresponds to a highest RSRP.

17. The apparatus of claim 1, further comprising a transceiver coupled to the at least one processor.

18. A method of wireless communication at a network node, comprising:
sending, to an intelligent reflecting surface (IRS), a first configuration for each candidate of a first set of candidates, the first set of candidates including different combinations of a first set of radial distances and a first set of azimuths;
communicating a reference signal (RS) with a user equipment (UE) via the IRS after each configuration is sent to the IRS;
determining a reference signal received power (RSRP) of each communicated RS for each candidate of the first set of candidates; and
sending a second configuration to the IRS, the second configuration being based on the determined RSRP.

19. The method of claim 18, wherein the first set of candidates includes different combinations of the first set of radial distances, the first set of azimuths, and a first set of elevations.

20. The method of claim 18, wherein the communicating the RS with the UE via the IRS comprises transmitting at least one of a synchronization signal block (SSB) or a channel state information (CSI) RS (CSI-RS) to the UE via the IRS.

21. The method of claim 20, wherein the determining the RSRP of each communicated RS for each candidate of the first set of candidates comprises receiving, from the UE, the RSRP of each RS transmitted to the UE via the IRS for each candidate of the first set of candidates.

22. The method of claim 18, wherein the communicating the RS with the UE via the IRS comprises receiving a sounding reference signal (SRS) from the UE via the IRS.

23. The method of claim 22, wherein the determining the RSRP of each communicated RS for each candidate of the first set of candidates comprises measuring the RSRP of each RS received from the UE via the IRS for each candidate of the first set of candidates.

24. The method of claim 18, wherein the second configuration is sent to the IRS for each candidate of a second set of candidates, the second set of candidates including different combinations of a second set of radial distances and a second set of azimuths, the second set of radial distances having a smaller range than the first set of radial distances, the second set of azimuths having a smaller range than the first set of azimuths.

25. The method of claim 24, wherein the first set of radial distances includes d1 radial distances, the first set of azimuths includes a1 azimuths, the second set of radial distances includes d2 radial distances, and the second set of azimuths includes a2 azimuths, where d2<d1 and a2<a1.

26. The method of claim 24, wherein the second set of candidates includes different combinations of the second set of radial distances, the second set of azimuths, and a second set of elevations.

27. The method of claim 24, further comprising:
sending a third configuration to the IRS, the third configuration being for a candidate in the second set of candidates that corresponds to a highest RSRP; and
communicating with the UE via the IRS based on the third configuration.

28. An apparatus for wireless communication at a network node, comprising:
means for sending, to an intelligent reflecting surface (IRS), a first configuration for each candidate of a first set of candidates, the first set of candidates including different combinations of a first set of radial distances and a first set of azimuths;
means for communicating a reference signal (RS) with a user equipment (UE) via the IRS after each configuration is sent to the IRS;
means for determining a reference signal received power (RSRP) of each communicated RS for each candidate of the first set of candidates; and
means for sending a second configuration to the IRS, the second configuration being based on the determined RSRP.

29. The apparatus of claim 28, further comprising a transceiver.

30. A computer-readable medium storing computer executable code at a network node, the code when executed by a processor causes the processor to:
send, to an intelligent reflecting surface (IRS), a first configuration for each candidate of a first set of candidates, the first set of candidates including different combinations of a first set of radial distances and a first set of azimuths;
communicate a reference signal (RS) with a user equipment (UE) via the IRS after each configuration is sent to the IRS;
determine a reference signal received power (RSRP) of each communicated RS for each candidate of the first set of candidates; and
send a second configuration to the IRS, the second configuration being based on the determined RSRP.
